(19) United States
(12) Patent Application Publication
(10) Pub. No.: US 2008/0236445 A1
(43) Pub. Date: Oct. 2, 2008

(54) Ink composition

(75) Inventor: Hee Jung Roh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd

(21) Appl. No.: 12/007,087

(22) Filed: Jan. 7, 2008

(30) Foreign Application Priority Data
Mar. 29, 2007 (KR) 10-2007-0030720

(51) Int. Cl. C09D 11/02; G01D 11/00

(52) U.S. Cl. 106/31.13; 347/100

(57) ABSTRACT

An ink composition and ink set makes a change of image color due to exposure to light incapable of being easily perceived. The ink composition and ink set for an inkjet printer which prints a color image by using three inks of yellow, magenta and cyan colors has features that each of the three colored inks have CIELab hue angles which move in the same direction (clockwise direction or counter-clockwise direction). Accordingly, the ink composition and ink set can maintain the color balance to the maximum even if the ink is faded due to light, thereby preserving the high quality color image for a long period.

### CROSS-REFERENCE TO RELATED APPLICATION

This application claims the benefit of Korean Patent Application No. 2007-0030720, filed on Mar. 29, 2007 in the Korean Intellectual Property Office, the disclosure of which is hereby incorporated by reference in its entirety.

### BACKGROUND OF THE INVENTION

1. Field of the Invention

The present invention relates to an ink composition. More particularly, the invention relates to an ink composition for providing an improved color image quality. The inks of the ink composition are selected according to the CIELab hue angles that move or shift in the same direction with respect to the color coordinate system as the color images fade and/or age.

2. Description of the Related Art

Yellow, magenta and cyan inks are typically used in a color inkjet printer, and a black ink is selectively used.

An ink used in an inkjet system should have a high reliability. In addition, inkjet inks preferably have a high image density, a quick dry performance, non-spread, non-formation of a spot when contacted by water or alcohol, long-term maintenance of image colors, and the like.

For the long-term maintenance of image colors, it is preferable to minimize damage by light or water. However, because an ink composition that is light and water stable and capable of perfectly overcoming the damage by light or water has not been developed yet, a color change to a certain extent cannot be avoided.

A major cause of deterioration of image preservation is fading by exposure to light. Japanese Patent Laid-Open Publication No. 2002-309140 discloses a technique that AE of each of long-term preserved inks is changed similarly by 10% or less and a residual ratio of reflection density after an experiment of light resistance is 70% or more. AE defines the difference between the color of the initial image and the color of the image after exposure to light in a CIELab color space. A difference between ΔE represents the difference in fading between images with two colors. The residual ratio of reflection density represents a value which indicates the reflection density of an image after light fading based on the reflection density of the image immediately after printing, which is set to be 100%. In the conventional technique, by regulating ΔE of each of the inks to be 10% or less and the residual ratio of reflection density to be 70% or more, the reflection density can be maintained to a certain extent and color balance can be preserved. Accordingly, the color image after light exposure gives a viewer little impression that the quality of the color image has deteriorated, even if the color image's light fading is recognizable.

However, although ΔE of each of the inks is changed similarly under the above condition, if values of the term a and the term b (which define the hue and the chroma characteristics of a given color, respectively) are changed in the opposite directions to each other, e.g., one value is changed in the “+” direction and the other value is changed in the “−” direction, the difference between the values of the terms a and b is increased up to 20%, and it may give the viewer the impression that the color image has faded.

### SUMMARY OF THE INVENTION

Therefore, it is an aspect of the invention to provide an ink composition that makes a change of image color due to exposure to light incapable of being easily perceived.

In accordance with an aspect of the invention, an ink composition is provided for an inkjet printer which prints a color image by using inks of three colors of yellow, magenta and cyan, the ink composition including the three colored inks with a CIELab hue angle, each of the CIELab hue angles moving in the same direction. The three colored inks in one embodiment of the invention are selected such that upon exposure to light, water and other effects of aging, the fading or color change of each ink shifts or moves in the same direction with respect to each other on the CIELab color coordinates. The three colored inks that exhibit a color shift with respect to the CIELab color coordinate system during aging reduces the perceived color change and fading as a result of aging and exposure to light.

The CIELab hue angles of the inks of three different colors change in the clockwise direction in one embodiment of the invention. The yellow ink uses a dye selected from the group consisting of D.Y.132, D.Y.86, and a combination thereof. The magenta ink uses a dye selected from the group consisting of R.R.180, R.R.24:1, D.R.75, R.R.245, and a combination thereof. The cyan ink uses a dye selected from the group consisting of A.B.9, D.B.199, and a combination thereof.

In another embodiment, the CIELab hue angles of each of the three colored inks are changed or shifted in the counter-clockwise direction with respect to the CIELab color coordinate system. The yellow ink uses a dye selected from the group consisting of A.Y23, A.Y.5, and a combination thereof. The magenta ink uses a dye selected from the group consisting of A.R.52, A.R.289, D.R.227, and a combination thereof, and the cyan ink uses a dye of D.B.86.

Additional aspects and/or advantages of the invention will be set forth in part in the description which follows and, in part, will be obvious from the description, or may be learned by practice of the invention.

### BRIEF DESCRIPTION OF THE DRAWING

These and/or other aspects and advantages of the exemplary embodiments of the invention will become apparent and more readily appreciated from the following description of the embodiments, taken in conjunction with the accompanying drawing, of which:

FIG. 1 is a view showing CIELab color coordinates in accordance with the present invention.

### DETAILED DESCRIPTION OF THE PREFERRED EMBODIMENTS

The present invention is directed to an ink composition including a cyan ink, a yellow ink and a magenta ink where each of the inks exhibit a hue angle shift in the same direction after a light test with respect to the CIELab color coordinates. One aspect of the invention is to provide an ink set for an inkjet printer where the ink set includes a cyan ink, a yellow ink and a magenta ink where each of the inks exhibit a hue angle shift in the same direction with respect to the CIELab coordinate system as the inks age and upon exposure to light. The hue angle shift in the same direction with respect to the CIELab color coordinate system reduces the amount of color change and fading that can be perceived by the observer.

Reference will now be made in detail to exemplary embodiments of the present invention, examples of which are illustrated in the accompanying drawing, wherein like reference numerals refer to like elements throughout. The embodiments are described below to explain the present invention by referring to the figure.

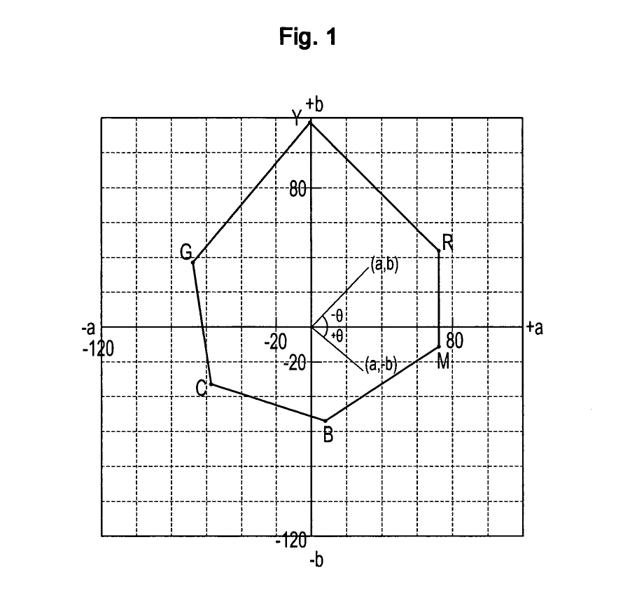

FIG. 1 shows the CIELab color coordinates according to the present invention. In a typical CIELab color space, a color is defined by using three terms of L, a and b. The term L defines the lightness of a color in the range from 0 (black) to 100 (white). The terms a and b define the hue and the chroma characteristics of a color, respectively. The term a is the red/green scale (+a is red, −a is green), and the term b is the yellow/blue scale (+b is yellow, −b is blue). The CIELab color coordinate system as used herein is as known by one skilled in the art and is used to indicate a perceived color quality of the inkjet inks of the invention.

The color coordinates in the present invention represent the color only by (a, b) coordinate values, except for L values which correspond to the lightness of the color. This is because the change of the L values is extremely small when ΔE is regulated to be 10% or less and the residual ratio of reflection density is regulated to be 70% or more. The ΔE defines the visually perceived or optically measured difference in color due to fading by exposure to light in a CIELab color space. In one embodiment of the invention, the ΔE of the inkjet ink is 10% or less. The residual ratio of reflection density represents a value indicating the reflection density of an image after light fading in relation to the reflection density of the image immediately after printing where the reflection density after printing is given a value of 100%. In one embodiment of the invention, the inkjet ink is selected to have a residual ratio of reflection density to be 70% or more.

Accordingly, the color of each ink can be represented by the angle from the X-axis to the (a, b) coordinate values which indicate the respective inks (tan θ=b/a, θ=tan⁻¹ (b/a)). When the coordinates are expressed by 0° to 360°, the clockwise direction from the X-axis is a direction in which the hue angle θ decreases, and the counter-clockwise direction from the X-axis is a direction in which the hue angle θ increases.

Referring to FIG. 1, the colors and hue are plotted according to the a, b coordinates of the CIELab color coordinates. As shown, a red dye (R) is in the upper right quadrant a+, b+ and the hue is determined by the angle θ. The green dye (G) is in the upper left quadrant a−, b+, the cyan ink is in the lower left quadrant a−, b−, and the magenta ink is in the lower right quadrant a+, b−. As the colors fade due to exposure to light, the hue angle changes. For example, when the hue angle of red shifts or moves in the counter-clockwise direction with respect to the coordinate chart of FIG. 1, the red becomes more greenish. In contrast, as the hue angle shifts in a clockwise direction, the red becomes more magenta.

The following Examples and Comparative Examples demonstrate the advantages of the inkjet inks of the invention. The inkjet ink set of the invention preferably are selected from a cyan, yellow and magenta where each of the cyan, yellow and magenta exhibit a CIELab hue angle shift in the same direction after the light resistance test. In one embodiment, each of the cyan, yellow and magenta exhibit a hue angle shift in a clockwise direction. In another embodiment, the cyan, yellow and magenta exhibit a hue angle shift in a clockwise direction. By selecting the cyan, yellow and magenta that exhibit a hue angle shift in the same direction, the perceived color change is less than when the colors exhibit a hue shift in opposite directions. In one embodiment, the colors are selected such that the amount of the hue shift is substantially the same or are selected to obtain the desire results.

In Table 1 below, the hue angle shift is shown for various commercially available dyes as a result of fading by exposure to light. In the Table, A.B. refers to acid blue, D.B. refers to direct blue, R.R. refers to reactive red, A.R. refers to acid red, A.Y. refers to acid yellow, and D.Y. refers to direct yellow as known in the art.

TABLE 1
Change of Direction of CIELab Hue angle Before and After Light
Resistance Test According to Dyes

| Cyan | direction | Magenta | direction | Yellow | direction |
|---|---|---|---|---|---|
| A.B.9 | clockwise | R.R.180 | clockwise | A.Y.23 | counter- |
| | | | | | clockwise |
| D.B.199 | clockwise | A.R.52 | counter- | D.Y.132 | clockwise |
| | | | clockwise | | |
| D.B.86 | counter- | A.R.289 | counter- | A.Y.5 | counter- |
| | clockwise | | clockwise | | clockwise |
| | | R.R.24:1 | clockwise | D.Y.86 | clockwise |
| | | D.R.227 | counter- | R.Y.37 | counter- |
| | | | clockwise | | clockwise |
| | | D.R.75 | clockwise | | |
| | | R.R.245 | clockwise | | |

Table 1 shows the representative dyes in which the CIELab hue angle θ moves in any one direction (clockwise direction or counter-clockwise direction) in the CIELab color coordinates, as a result of the light resistance test. The shift or movement of the hue angle θ represents the change in visually perceived hue or color upon exposure to light over time as measured by the CIELab hue color test as known in the art.

The inks are manufactured by mixing predetermined coloring agents and additives and adding water to the above representative dyes to 100 g, stirring sufficiently the mixture in a stirrer for 30 minutes, and filtering the mixture by using a 0.45 μm filter. As the additives, 6 parts by weight of DEG (diethylene glycol), 10 parts by weight of EG (ethylene glycol), 5 parts by weight of IPA (isopropyl alcohol), and 0.2 parts by weight of Tween 20 are used. Ion-exchanged water is further added to the dyes (the parts by weight of the dyes are shown in the following Table 2) so that the total of the parts by weight of the components is 100 parts by weight. Other known methods for producing inkjet inks can also be used. As a result, the manufactured inks have features of regulating ΔE to be 10% or less and the residual ratio of reflection density to be 70% or more.

TABLE 2
Inks Manufactured by Using Dyes in Table 1

| Dyes | C-1 | C-2 | C-3 | M-1 | M-2 | M-3 | M-4 | M-5 | M-6 | M-7 | Y-1 | Y-2 | Y-3 | Y-4 | Y-5 |
|---|---|---|---|---|---|---|---|---|---|---|---|---|---|---|---|
| A.B.9 | 4.5 | | | | | | | | | | | | | | |
| D.B.199 | | 4 | | | | | | | | | | | | | |
| D.B.86 | | | 4 | | | | | | | | | | | | |
| R.R.180 | | | | 4 | | | | | | | | | | | |
| A.R.52 | | | | | 4.5 | | | | | | | | | | |
| A.R.289 | | | | | | 3.6 | | | | | | | | | |
| R.R.24:1 | | | | | | | 4.5 | | | | | | | | |
| D.R.227 | | | | | | | | 4 | | | | | | | |
| D.R.75 | | | | | | | | | 5 | | | | | | |
| R.R.245 | | | | | | | | | | 3.5 | | | | | |
| A.Y.23 | | | | | | | | | | | 4 | | | | |
| D.Y.132 | | | | | | | | | | | | 3.6 | | | |
| A.Y.5 | | | | | | | | | | | | | 4.2 | | |
| D.Y.86 | | | | | | | | | | | | | | 4 | |
| R.Y.37 | | | | | | | | | | | | | | | 5 |
| Residual | 85 | 75 | 91 | 92 | 91 | 85 | 73 | 84 | 76 | 66 | 74 | 82 | 88 | 78 | 75 |
| Ratio of | | | | | | | | | | | | | | | |
| Reflection | | | | | | | | | | | | | | | |
| Density (%) | | | | | | | | | | | | | | | |
| ΔE | 5 | 8 | 10 | 2 | 7 | 10 | 9 | 13 | 5 | 24 | 8 | 6 | 15 | 1 | 35 |
| Direction of | C | C | A | C | A | A | C | A | C | C | A | C | A | C | A |
| Hue Angle | | | | | | | | | | | | | | | |

A.B.—Acid Blue,
D.B.—Direct Blue
A.R.—Acid Red,
D.R.—Direct Red,
R.R.—Reactive Red
A.Y.—Acid Yellow,
D.Y.—Direct Yellow,
R.Y.—Reactive Yellow

In Table 2, the inks C1-C3 are cyan inks, M1-M7 are magenta inks, and Y1-Y5 are yellow inks.

The light resistance test of the inks having the composition shown in Table 2 is performed as follows: (1) the ink is charged into the C-60 (Lex foam) cartridge in the MJC-printer 3300p printer and the image is printed by using a Korean word processor software (e.g., “Hunmin Jeong-eum”), (2) the residual ratio of reflection density and the CIELab AE are measured by using the Mecbath Spectrol equipment, (3) the printed image is stored in the Q-Sun for 10 hours, and (4) the residual ratio of reflection density and the CIELab AE are remeasured by using the Mecbath Spectrol equipment. The light resistance test is according to the CIELab testing procedures as known by one skilled in the art.

The Comparative Examples were prepared from the cyan, magenta and yellow inks where one of the inks exhibit a hue angle shift in a direction opposite to the other inks.

TABLE 3
Comparative Examples

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| Cyan | C-1 | C-2 | C-3 | C-1 | C-3 |
| Magenta | M-2 | M-7 | M-4 | M-5 | M-6 |
| Yellow | Y-1 | Y-3 | Y-2 | Y-4 | Y-5 |

Table 3 shows the Comparative Examples in which the inks or ink sets are manufactured by combining the inks of which the CIELab hue angles θ change in the clockwise direction (C-1, C-2, M-4, M-6, M-7, Y-2, Y-4) with the inks of which the CIELab hue angles θ are changed in the counter-clockwise direction (C-3, M-2, M-5, Y-1, Y-3, Y-5). For instance, in the Comparative Example 1, because yellow (Y-1) moves in the counter-clockwise direction toward green and cyan (C-1) moves in the clockwise direction toward green, i.e., all of them move toward green as shown in the CIELab coordinate system of FIG. 1, the total image color becomes greenish. In the Comparative Example 2, magenta (M-7) moves in the counter-clockwise direction toward red when faded, cyan (C-2) moves clockwise and yellow (Y-3) moves counter-clockwise all toward green, similar to the Comparative Example 1, and thus the total image color becomes greenish. In the Comparative Example 3, because cyan (C-3) moves in the counter-clockwise direction toward blue and magenta (M-4) moves in the clockwise direction toward blue, i.e., all of them move toward blue, and the total image color becomes bluish. In the Comparative Example 4, because yellow (Y-4) moves in the clockwise direction toward red and magenta (M-5) moves in the counter-clockwise direction toward red, i.e., all of them move toward red, and the total image color becomes reddish. In the Comparative Example 5, yellow (Y-5) moves in the counter-clockwise direction toward blue/green when faded, cyan (C-3) moves in the counter-clockwise direction toward blue and magenta (M-6) moves in the clockwise direction toward blue, all move toward blue, and thus the total image color becomes bluish.

TABLE 4
Embodiments

| | Embodi- | Embodi- | Embodi- | Embodi- | Embodi- |
|---|---|---|---|---|---|
| | ment 1 | ment 2 | ment 3 | ment 4 | ment 5 |
| Cyan | C-1 | C-2 | C-3 | C-1 | C-3 |
| Magenta | M-1 | M-4 | M-3 | M-6 | M-5 |
| Yellow | Y-2 | Y-4 | Y-1 | Y-2 | Y-5 |

Table 4 shows the embodiments in which the inks or ink sets are manufactured by combining the inks of which the CIELab hue angles θ are changed in the clockwise direction (C-1, C-2, M-1, M-4, M-6, Y-2, Y-4) with each other, or combining the inks of which the CIELab hue angles θ are changed in the counter-clockwise direction (C-3, M-2, M-5, Y-1, Y-5) with each other. Like this, if the inks are manufactured by combining the inks having the same direction of hue angle shift with each other, though the fading due to exposure to light occurs, the color balance can be maintained, thereby preserving the clear color image. In one embodiment, the inks are selected to exhibit a hue color shift in the same direction such that for each colored ink is proportional to reduce the visually perceived color change.

If using the features that Y-color is biased toward red when the CIELab hue angle θ moves in the clockwise direction, the ink can be efficiently used in a portrait in which an apricot color expression is important. If using the features that Y-color is biased toward green when the CIELab hue angle θ moves in the counter-clockwise direction, the ink can be efficiently used in a landscape picture. Accordingly, the more subdivided inks for special work can be manufactured by combining the inks according to the CIELab hue angle θ.

As apparent from the above description, the ink composition according to the present invention can maintain the color balance to the maximum even if the ink is faded due to light, thereby preserving the high quality color image during a long period.

In one embodiment of the invention, the ink composition and ink set include a yellow, magenta and cyan ink where each of the inks contain only dyes that exhibit either a CIELab hue angle shift in a clockwise direction or only dyes that exhibit a CIELab hue angle shift in a counter-clockwise direction. In this manner, the ink set is made up of inks that consist essentially of inks that exhibit a hue angle shift in either a clockwise direction or a counter-clockwise direction. The inks preferably include only dyes that exhibit a hue angle shift in the same direction.

Another aspect of the invention is directed to a method of producing a printed image from an inkjet printer using the ink set of the invention. The ink set includes a cyan ink, a magenta ink and a yellow ink where each of the inks exhibit a CIELab hue angle shift in the same direction. The printed image exhibits a reduced perceived color change due to fading over time compared to other ink sets.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink composition for an inkjet printer which prints a color image using three inks of yellow, magenta and cyan colors, wherein:
the three colors of inks have CIELab hue angles, the CIELab hue angles moving in the same direction upon exposure to light.

2. The ink composition according to claim 1, wherein the CIELab hue angles of the three colored inks shift in a clockwise direction.

3. The ink composition according to claim 2, wherein the yellow ink includes a dye selected from the group consisting of D.Y.132, D.Y.86, and combinations thereof, the magenta ink includes a dye selected from the group consisting of R.R.180, R.R.24:1, D.R.75, R.R.245, and combinations thereof, and the cyan ink includes a dye selected from the group consisting of A.B.9, D.B.199, and combinations thereof.

4. The ink composition according to claim 1, wherein the CIELab hue angles of the three colored inks shift in a counter-clockwise direction.

5. The ink composition according to claim 4, wherein the yellow ink includes a dye selected from the group consisting of A.Y.23, A.Y.5, and combinations thereof, the magenta ink includes a dye selected from the group consisting of A.R.52, A.R.289, D.R.227, and combinations thereof, and cyan the ink includes a dye of D.B.86.

6. An ink set for an inkjet printer comprising a yellow ink, a magenta ink and a cyan ink, wherein each of said inks exhibit a CIELab hue angle shift in the same direction with respect to a CIELab coordinate system upon exposure to light.

7. The ink set of claim 6, wherein each of said inks exhibit a CIELab hue angle shift in a clockwise direction.

8. The ink set of claim 6, wherein each of said inks exhibit a CIELab hue angle shift in a counter-clockwise direction.

9. The ink set of claim 6, wherein said yellow ink includes a dye selected from the group consisting of D.Y.132, D.Y.86, and combinations thereof, said magenta ink includes a dye selected from the group consisting of R.R.180, R.R.24:1, D.R.75, R.R.245, and combinations thereof, and said cyan ink includes a dye selected from the group consisting of A.B.9, D.B.199, and combinations thereof.

10. The ink set of claim 6, wherein said yellow ink includes a dye selected from the group consisting of A.Y.23, A.Y.5, and combinations thereof, said magenta ink includes a dye selected from the group consisting of A.R.52, A.R.289, D.R.227, and combinations thereof, and the cyan ink includes D.B.86.

11. A method of producing a printed image having a reduced perceived color change over time, the method comprising:
printing an image from an inkjet printer, where the inkjet printer uses an ink set including a cyan ink, a magenta ink and a yellow ink, and where each of said inks exhibit a CIELab hue angle shift in the same direction with respect to a CIELab coordinate system upon exposure to light.

12. The method of claim 11, wherein each of said inks include dye that exhibit a CIELab hue angle shift in a clockwise direction.

13. The method of claim 11, wherein each of said inks include a dye that exhibits a CIELab hue angle shift in a counter-clockwise direction.
